(19) United States
(12) Patent Application Publication
(10) Pub. No.: US 2024/0378745 A1
(43) Pub. Date: Nov. 14, 2024

(54) Pose graph SLAM computation method and system based on 4D millimeter-wave radar

(71) Applicants: Shanghai Jiao Tong University, Shanghai (CN); ZF (China) Investment Co., Ltd., Shanghai (CN)

(72) Inventors: Han Zhang, Shanghai (CN); Xingyi Li, Shanghai (CN); Weidong Chen, Shanghai (CN); Changhe Liu, Shanghai (CN); Jingchuan Wang, Shanghai (CN)

(21) Appl. No.: 18/661,026

(22) Filed: May 10, 2024

(30) Foreign Application Priority Data
May 11, 2023 (CN) 202310532630.2

(51) Int. Cl. G06T 7/73; G01S 13/60; G01S 13/89; G06T 7/33

(52) U.S. Cl. CPC G06T 7/73; G01S 13/60; G01S 13/89; G06T 7/337; G06T 2207/10028; G06T 2207/10044

(57) ABSTRACT

A pose graph synchronous localization and mapping computation method based on a 4D millimeter-wave radar includes comparing two consecutive frames of point clouds in a 4D radar point cloud to remove ghost points below a ground surface and random points, estimating a linear velocity and an angular velocity of a device based on Doppler velocity information in the 4D radar point cloud, and estimating and constructing a pose graph using a relative pose transformation, and estimating an optimal pose for the pose graph through graph optimization. To achieve better accuracy for a sparse point cloud, estimated ego vehicle velocity is pre-integrated to obtain an additional relative pose estimate, and loop closure detection is used to identify places already reached.

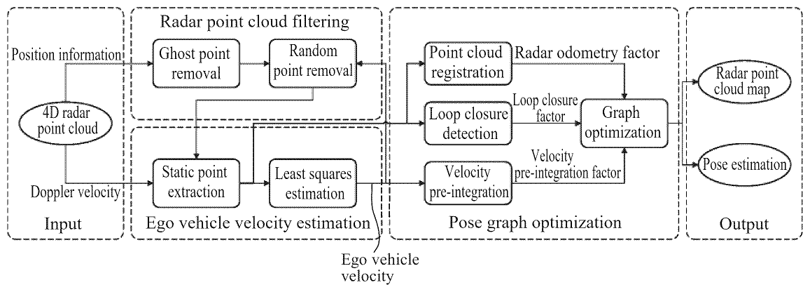

### CROSS-REFERENCE TO RELATED APPLICATION

The present application is related and has right of priority to Chinese Patent Application No. 202310532630.2 filed on May 11, 2023, the entirety of which is incorporated by reference for all purposes.

### TECHNICAL FIELD

The present invention relates generally to the field of robot technologies, and specifically to a pose graph SLAM computation method and system based on a 4D millimeter-wave radar.

### BACKGROUND OF THE INVENTION

Millimeter-wave radars have been widely used in the synchronous localization and mapping (SLAM) technology, especially in the field of autonomous driving. Compared with optical sensors such as a camera or lidar, the millimeter-wave radar is less sensitive to weather and light conditions and is much cheaper. However, despite these advantages, the millimeter-wave radar usually has a sparser point cloud and larger noise compared to the lidar, which poses challenges for precise localization and mapping. In recent years, the latest millimeter-wave radar sensor, namely 4D imaging radar (4D radar), has received increasing attention in autonomous driving due to its unique advantages over conventional radars.

Conventional millimeter-wave radars may be divided into two types: scanning radars and automotive radars. The scanning radar performs a 360-degree scan on the surrounding environment, and provides a two-dimensional radar energy image without velocity information. The automotive radar usually has a smaller field of view and provides a sparse 2D point cloud with a Doppler velocity. Compared with conventional millimeter-wave radar sensors, the 4D radar has a longer detection distance and a larger field of view. A 4D point cloud provided by the 4D radar has information in four dimensions: distance, azimuth angle, elevation angle, and Doppler velocity. In addition, the 4D radar also provides some low-level features, such as an energy intensity or a radar scattering cross section. Because the 4D radar has additional information and higher resolution, it provides new opportunities for the application of SLAM.

Regarding the issue of millimeter-wave radar SLAM technology, researchers have done a lot of research. According to the types of millimeter-wave radars applied, the millimeter-wave radar SLAM algorithms may be roughly divided into two types.

One type is a SLAM algorithm based on the scanning radar, which occupy a dominant position in millimeter-wave radar SLAM. This type of algorithm uses 2D images obtained by the scanning radar as an input, and usually uses some feature extraction algorithms to extract feature points from the images, and then performs scanning registration based on the feature points. The most famous of the algorithms is the RadarSLAM algorithm proposed by Hong et al. (Z. Hong, Y. Petillot, and S. Wang, “RadarSLAM: Radar based Large-Scale SLAM in All Weathers,” in 2020 IEEE/RSJ International Conference on Intelligent Robots and Systems (IROS), October 2020, pp. 5164-5170, ISSN: 2153-086). Inspired by visual SLAM related methods, they extract SURF feature points from radar images and perform registration. In addition, there are also some methods implementing scanning radar SLAM using deep learning. However, these methods are not applicable to 4D radar point clouds because they use 2D scanning radar images as an input.

The other type is a SLAM algorithm based on the automotive radar. This type of algorithm uses a sparse radar point cloud obtained by a conventional automotive radar as an input, and uses Doppler velocity information in the point cloud or scanning registration of the point cloud to estimate ego vehicle motion. Kellner et al. (D. Kellner, M. Barjenbruch, J. Klappstein, J. Dickmann, and K. Dietmayer, “Instantaneous ego-motion estimation using Doppler radar,” in 16th International IEEE Conference on Intelligent Transportation Systems (ITSC 2013), October 2013, pp. 869-874, ISSN: 2153-0017.) The algorithm uses the Doppler velocity information in the radar point cloud to compute an ego vehicle velocity, thereby implementing ego vehicle motion estimation. Kung et al. proposed a radar odometry algorithm suitable for scanning radars and automotive radars. (P.-C. Kung, C.-C. Wang, and W.-C. Lin, “A Normal Distribution Transform-Based Radar Odometry Designed For Scanning and Automotive Radars,” in 2021 IEEE International Conference on Robotics and Automation (ICRA). Xi′an, China: IEEE, May 2021, pp. 14 417-14 423.). Kung et al. uses the ego vehicle velocity estimation method proposed by Kellner et al. to merge a plurality of frames of radar point clouds into a radar submap. Then, scanning matching based on a normal distribution transformation is applied to perform matching between two radar submaps, implementing ego vehicle motion estimation. However, the radar submap is only a simple superposition of consecutive radar point clouds using the ego vehicle velocity estimation, so its accuracy depends largely on the accuracy of the ego vehicle velocity estimation.

Patent document CN111522043A discloses an unmanned vehicle lidar rapid rematching and positioning method, which relates to the field of unmanned driving. This method is divided into a multi-sensor calibration module, a pose fusion module, and a fusion positioning module. Through multi-sensor joint calibration, consistency description of a target is obtained. Data fusion is performed on pose information of an unmanned vehicle resolved by a GPS sensor and a lidar sensor, to obtain vehicle pose information fused by the GPS sensor and the lidar sensor. When point cloud matching of a lidar SLAM positioning module fails, a fused pose is used for replacing a positioning prediction matrix of a point cloud matching algorithm, rapid re-matching of the lidar SLAM algorithm is implemented, and continuous positioning of the unmanned vehicle SLAM algorithm is implemented. However, this method does not introduce loop closure detection to identify places that have been reached again, and therefore cannot optimize historical poses from a global perspective.

### SUMMARY OF THE INVENTION

The present invention provides a pose graph SLAM computation method and system based on a 4D millimeter-wave radar.

The pose graph SLAM computation method based on a 4D millimeter-wave radar provided according to the present invention includes:
step S1: extracting a ground point cloud, and comparing two consecutive frames of point clouds, to remove ghost points below the ground and random points;
step S2: estimating a linear velocity and an angular velocity of a device based on Doppler velocity information in a 4D radar point cloud; and
step S3: estimating and constructing a pose graph using a relative pose transformation that is obtained through point cloud registration performed based on a normal distribution transformation, pre-integration performed using an estimated device velocity, and loop closure detection; and estimating an optimal pose through graph optimization.

Preferably, in step S1, the ground point cloud is extracted, and the two consecutive frames of point clouds are compared, to remove the ghost points below the ground and the unstable random points, so as to reduce noise in the 4D radar point cloud.

Step S1 includes step S1.1: ghost point removal, where the ground point cloud is extracted from an original radar point cloud and the ghost points below the ground are filtered out;

For the original radar point cloud [symbol] ={Pᵢ}, i ∈{1, 2, . . . , n} measured by a 4D radar, n is a number of points in the point cloud. A position of each point in a radar coordinate system is expressed as Pᵢ=(xᵢ, yᵢ, zᵢ)=(rᵢ cos θᵢ cos φᵢ, r; sin θᵢ cos φᵢ, rᵢ sin φᵢ)^{T}, where rᵢ is a distance of the point measured by the 4D radar, θᵢ is an azimuth angle of the point measured by the 4D radar, and o; is an elevation angle of the point measured by the 4D radar. For the original radar point cloud, a point with a distance less than a threshold δᵣ and a height within a threshold δₕ near a mounting height of the radar is retained, an upward normal vector of each point is computed using a principal component analysis method, a point with a normal vector having an angle less than on with a z-axis positive unit vector is retained, ground points are extracted using a random sample consensus algorithm, and the ghost points below the ground are filtered out; and

Step S1 further includes step S1.2: random point removal, where the random points are identified and filtered out by comparing a current point cloud and a previous frame of point cloud adjacent to the current point cloud, for the current point cloud and the previous frame of point cloud adjacent to the current point cloud, a pose transformation between the current point cloud and the previous frame of point cloud is computed based on the device velocity, the previous frame of point cloud is transformed into a coordinate system of the current frame, and if the transformed previous frame of point cloud does not exist within a preset range near a point in the current frame, the point is classified as a random point and filtered out.

A rotation transformation Rₖ₋₁ and a translation transformation tₖ₋₁ between the current point cloud [symbol] ₖ and the previous frame of point cloud [symbol] ₖ₋₁ adjacent to the current point cloud are computed:

$${t}_{k - 1} = {\tilde{v}}_{k - 1} Δ t \\ {R}_{k - 1} = Exp ( {\tilde{ω}}_{k - 1} Δ t )$$

where νₖ₋₁ and ωₖ₋₁ are respectively a device linear velocity estimate and a device angular velocity estimate of the previous frame, Δt is a time difference between the two frames, Exp(·):R³→SO (3) is an exponential mapping of a three-dimensional rotation, R³ is a three-dimensional real number vector space, SO(3) is a three-dimensional special orthogonal group, and [symbol] ₖ₋₁ is obtained by transforming the previous frame of point cloud into the coordinate system of the current frame using Rₖ₋₁ and tₖ₋₁; and if no point in [symbol] ₖ₋₁ exists within a preset range of a point in the current frame, the current point is classified as a random point and filtered out.

Preferably, step S2 includes step S2.1: static point extraction, where for an i^{th} point in the 4D radar point cloud, a relationship between a Doppler velocity of the point and a velocity of the radar is as follows:

$${v}_{r , i} = - {d}_{i} \cdot {v}_{s}$$

where ν_{r,i} is the Doppler velocity of the i^{th} point, dᵢ=(cos θᵢ cos dᵢ, sin θᵢ cos dᵢ, sin dᵢ) T is a unit direction vector of the point relative to the radar, and vs is the velocity of the radar; and

a relationship between the velocity of the radar and the device velocity is as follows:

$${ν}_{s} = {R}_{s}^{T} ( \tilde{ν} + \tilde{ω} \times {t}_{s} )$$

where tₛ and Rₛ are respectively a mounting position and a pose of the 4D radar in a device coordinate system, ν∈R³ and ω∈R³ are respectively the linear velocity and the angular velocity of the device, and for all static points in the 4D radar point cloud, the Doppler velocity and the device velocity both conform to the following equation:

$$- [ \begin{matrix}{v}_{r , 1} \\ ⋮ \\ {v}_{r , m}\end{matrix} ] = [ \begin{matrix}{{d}_{i}}^{T} \\ ⋮ \\ {{d}_{m}}^{T}\end{matrix} ] {R}_{s}^{T} [ \begin{matrix}{I}_{3 \times 3} & - {t}_{s}^{∧}\end{matrix} ] [ \begin{matrix}\tilde{v} \\ \tilde{ω}\end{matrix} ] ,$$

where m is a number of all the static points in the point cloud, I_{3×3} is a 3×3 unit matrix, tₛ ∈R^{3×3} is an antisymmetric matrix of tₛ, R^{3×3} represents a set of 3×3 real matrices, and dynamic outliers are removed and the static points are extracted based on relationships between Doppler velocities of all the static points in the radar point cloud and the device velocity using the random sample consensus algorithm.

Step S2 further includes step S2.2: least squares estimation, where after the static points are extracted, the device velocity is computed based on the relationships between the Doppler velocities of all the static points and the device velocity using the least square method.

Preferably, in step S3, pose graph optimization is performed, where the pose graph is estimated and constructed using the relative pose transformation that is obtained through the point cloud registration, the velocity pre-integration, and the loop closure detection; and finally the optimal pose is estimated through the graph optimization.

Step S3 includes step S3.1: point cloud registration based on the normal distribution transformation, where a relative transformation is estimated by matching between a current 4D radar point cloud and a keyframe submap. a radar submap is established using a plurality of keyframe point clouds and a sliding window, if a translation or rotation from a last keyframe to a current point cloud exceeds a threshold, a current frame is selected as a new keyframe, the new keyframe is added to the radar submap, and when a number of keyframes in the submap exceeds a size of the window, the earliest keyframe is discarded. After the radar submap is established, the submap is evenly divided into grids of a same size, a point cloud in each grid is modeled as a local normal distribution, measurement uncertainty of each point is considered when computing a mean and a covariance of the normal distribution, and the current 4D radar point cloud is registered with the radar submap to compute a relative pose transformation that maximizes a distribution probability of the current point cloud in the submap, where an error of estimation of the pose transformation is e_{O}; and

Step S3 further includes step S3.2: velocity pre-integration, where the relative pose transformation is computed based on the estimated device velocity, so that an additional reliable relative pose estimate is introduced, and a device linear velocity and a device angular velocity that are estimated at a moment t are respectively denoted as νₜ and ωₜ, with their estimated values being true values each plus a zero-mean Gaussian white noise:

$${\tilde{ω}}_{t} = {ω}_{t} + {η}_{t}^{ω} ,$$

$${\tilde{v}}_{t} = {R}_{tW}^{T} {v}_{t} + {η}_{t}^{v} ,$$

where ωₜ and _{w}Vₜ are respectively the true values of the angular velocity and the linear velocity in a world coordinate system, nₜ^{w} and nₜ^{ν} are corresponding noise terms, Rₜ is an orientation of the device in the world coordinate system, a relative rotation transformation ΔRᵢⱼ and a relative translation transformation Δpᵢⱼ between a moment i and a moment j are obtained by integration, and an error of estimation of the pose transformation is e_{V}.

Preferably, step S3 further includes step S3.3: loop closure detection, where a position that has been previously reached is identified, in polar coordinates, the 4D radar point cloud is divided into grids, a 3D point cloud is mapped to a 2D matrix, a value of each element in the matrix is a maximum energy intensity of radar points in a corresponding grid, as the device moves, a cosine distance between a 2D matrix of the current frame and a 2D matrix generated by each of all previous keyframes is continuously searched for and computed, and if the distance is less than a set threshold, it is considered that a loop closure has been detected. When a loop closure is detected, a relative pose transformation between the current frame and a submap composed of a loop closure frame and nearby keyframes is computed; and an error of estimation e_{L}; of the pose transformation is determined.

Step S3 further includes step S3.4: graph optimization, where the pose graph is established, error terms of relative pose estimates at all moments are considered, optimal poses of the device at all moments are estimated through graph optimization, all nodes in the pose graph correspond to poses at different moments, and edges between the nodes correspond to relative pose transformations between different moments; and all the poses are expressed as X={xᵢ}, i∈ [symbol] , and the optimal pose X* is estimated by solving a nonlinear least squares problem:

$${x}^{*} = arg {min}_{x} {e}_{O} + {e}_{V} + {e}_{L}$$

where [symbol] includes all moments, and e_{O}, eᵥ, e_{L} respectively correspond to the errors of relative pose transformations obtained in different steps.

A pose graph SLAM computation system based on a 4D millimeter-wave radar provided according to the present invention includes:
a module M1 configured to extract a ground point cloud, and compare two consecutive frames of point clouds, to remove ghost points below the ground and random points;
a module M2 configured to estimate a linear velocity and an angular velocity of a device based on Doppler velocity information in a 4D radar point cloud; and
a module M3 configured to estimate and construct a pose graph using a relative pose transformation that is obtained through point cloud registration performed based on a normal distribution transformation, pre-integration performed using an estimated device velocity, and loop closure detection; and estimate an optimal pose through graph optimization.

Preferably, in the module M1, the ground point cloud is extracted, and the two consecutive frames of point clouds are compared, to remove the ghost points below the ground and the unstable random points, so as to reduce noise in the 4D radar point cloud.

A module M1.1 of module M1 is configured to perform ghost point removal, where the ground point cloud is extracted from an original radar point cloud and the ghost points below the ground are filtered out. For the original radar point cloud [symbol] ={Pᵢ}, i∈{1, 2, . . . , n} measured by a 4D radar, n is a number of points in the point cloud. A position of each point in a radar coordinate system is expressed as Pᵢ=(xᵢ, yᵢ, zᵢ)^{T}=(rᵢ cos θᵢ cos φᵢ, rᵢ sin θᵢ cos φᵢ, rᵢ sin φᵢ)^{T}, where r; is a distance of the point measured by the 4D radar, θᵢ is an azimuth angle of the point measured by the 4D radar, and φᵢ is an elevation angle of the point measured by the 4D radar. For the original radar point cloud, a point with a distance less than a threshold δᵣ and a height within a threshold δₕ near a mounting height of the radar is retained, an upward normal vector of each point is computed using a principal component analysis method, a point with a normal vector having an angle less than on with a z-axis positive unit vector is retained, ground points are extracted using a random sample consensus algorithm, and the ghost points below the ground are filtered out.

A module M1.2 of module M1 is configured to perform random point removal, where the random points are identified and filtered out by comparing a current point cloud and a previous frame of point cloud adjacent to the current point cloud, for the current point cloud and the previous frame of point cloud adjacent to the current point cloud, a pose transformation between the current point cloud and the previous frame of point cloud is computed based on the device velocity, the previous frame of point cloud is transformed into a coordinate system of the current frame, and if the transformed previous frame of point cloud does not exist within a preset range near a point in the current frame, the point is classified as a random point and filtered out.

A rotation transformation Rₖ₋₁ and a translation transformation tₖ₋₁ between the current point cloud [symbol] ₖ and the previous frame of point cloud [symbol] ₖ₋₁ adjacent to the current point cloud are computed:

$${t}_{k - 1} = {\tilde{v}}_{k - 1} Δ t$$

$${R}_{k - 1} = Exp ( {\tilde{ω}}_{k - 1} Δ t )$$

where νₖ₋₁ and ωₖ₋₁ are respectively a device linear velocity estimate and a device angular velocity estimate of the previous frame, Δt is a time difference between the two frames, Exp(·):R³→SO(3) is an exponential mapping of a three-dimensional rotation, R³ is a three-dimensional real number vector space, SO(3) is a three-dimensional special orthogonal group, and [symbol] ₖ₋₁′ is obtained by transforming the previous frame of point cloud into the coordinate system of the current frame using Rₖ₋₁ and tₖ₋₁. If no point in [symbol] ₖ₋₁′ exists within a preset range of a point in the current frame, the current point is classified as a random point and filtered out.

Preferably, in the module M2, a module M2.1 is configured to perform static point extraction, where for an i^{th} point in the 4D radar point cloud, a relationship between a Doppler velocity of the point and a velocity of the radar is as follows:

$${v}_{r , i} = - {d}_{i} \cdot {v}_{s}$$

where ν_{r,i} is the Doppler velocity of the i^{th} point, dᵢ=(cos θᵢ cos Pᵢ, sin θᵢ cos dᵢ, sin Pᵢ)^{T} is a unit direction vector of the point relative to the radar, and vs is the velocity of the radar.

A relationship between the velocity of the radar and the device velocity is as follows:

$${ν}_{s} = {R}_{s}^{T} ( \tilde{ν} + \tilde{ω} \times {t}_{s} )$$

where tₛ and Rₛ are respectively a mounting position and a pose of the 4D radar in a device coordinate system, v∈R³ and ω∈R³ are respectively the linear velocity and the angular velocity of the device, and for all static points in the 4D radar point cloud, the Doppler velocity and the device velocity both conform to the following equation:

$$- [ \begin{matrix}{v}_{r , 1} \\ ⋮ \\ {v}_{r , m}\end{matrix} ] = [ \begin{matrix}{d}_{i}^{T} \\ ⋮ \\ {d}_{m}^{T}\end{matrix} ] {R}_{s}^{T} [ {I}_{3 \times 3} - {t}_{s}^{⋀} ] [ \begin{matrix}\tilde{v} \\ \tilde{ω}\end{matrix} ] ,$$

where m is a number of all the static points in the point cloud, I_{3×3} is a 3×3 unit matrix, tₛ, ∈R^{3×3} is an antisymmetric matrix of tₛ, R^{3×3} represents a set of 3×3 real matrices, and dynamic outliers are removed and the static points are extracted based on relationships between Doppler velocities of all the static points in the radar point cloud and the device velocity using the random sample consensus algorithm.

A module M2.2 of module M2 is configured to perform least squares estimation, where after the static points are extracted, the device velocity is computed based on the relationships between the Doppler velocities of all the static points and the device velocity using the least square method.

Preferably, in the module M3, pose graph optimization is performed, where the pose graph is estimated and constructed using the relative pose transformation that is obtained through the point cloud registration, the velocity pre-integration, and the loop closure detection; and finally the optimal pose is estimated through the graph optimization.

A module M3.1 of module M3 is configured to perform point cloud registration based on the normal distribution transformation, where a relative transformation is estimated by matching between a current 4D radar point cloud and a keyframe submap. A radar submap is established using a plurality of keyframe point clouds and a sliding window. If a translation or rotation from a last keyframe to a current point cloud exceeds a threshold, a current frame is selected as a new keyframe, the new keyframe is added to the radar submap, and when a number of keyframes in the submap exceeds a size of the window, the earliest keyframe is discarded.

After the radar submap is established, the submap is evenly divided into grids of a same size, a point cloud in each grid is modeled as a local normal distribution, measurement uncertainty of each point is considered when computing a mean and a covariance of the normal distribution, and the current 4D radar point cloud is registered with the radar submap to compute a relative pose transformation that maximizes a distribution probability of the current point cloud in the submap, where an error of estimation e_{O} of the pose transformation is determined.

A module M3.2 of the module M3 is configured to perform velocity pre-integration, where the relative pose transformation is computed based on the estimated device velocity, so that an additional reliable relative pose estimate is introduced, and a device linear velocity and a device angular velocity that are estimated at a moment t are respectively denoted as νₜ and ωₜ, with their estimated values being true values each plus a zero-mean Gaussian white noise:

$${\tilde{ω}}_{t} = {ω}_{t} + {η}_{t}^{ω} ,$$

$${\tilde{ν}}_{t} = {R}_{t}^{T} {}_{W} {v}_{t} + {η}_{t}^{v} ,$$

where ωₜ and _{w}Vₜ are respectively the true values of the angular velocity and the linear velocity in a world coordinate system, nₜ^{ω} and nₜ^{ν} are corresponding noise terms, Rₜ is an orientation of the device in the world coordinate system, a relative rotation transformation ΔRᵢⱼ and a relative translation transformation Δpᵢⱼ between a moment i and a moment j are obtained by integration, and an error of estimation of the pose transformation is eᵥ.

Preferably, a module M3.3 of the module M3 is configured to perform loop closure detection, where a position that has been previously reached is identified, in polar coordinates, the 4D radar point cloud is divided into grids, a 3D point cloud is mapped to a 2D matrix, a value of each element in the matrix is a maximum energy intensity of radar points in a corresponding grid, as the device moves, a cosine distance between a 2D matrix of the current frame and a 2D matrix generated by each of all previous keyframes is continuously searched for and computed, and if the distance is less than a set threshold, it is considered that a loop closure has been detected; when a loop closure is detected, a relative pose transformation between the current frame and a submap composed of a loop closure frame and nearby keyframes is computed; and an error of estimation e_{L} of the pose transformation is determined.

A module M3.4 is configured to perform graph optimization, where the pose graph is established, error terms of relative pose estimates at all moments are considered, optimal poses of the device at all moments are estimated through graph optimization, all nodes in the pose graph correspond to poses at different moments, and edges between the nodes correspond to relative pose transformations between different moments. All the poses are expressed as X={xᵢ}, i∈ [symbol] , and the optimal pose X* is estimated by solving a nonlinear least squares problem:

$${x}^{*} = arg {min}_{x} {e}_{O} + {e}_{V} + {e}_{L}$$

where [symbol] includes all moments, and e_{O}, eᵥ, e_{L} respectively correspond to the errors of relative pose transformations obtained in different steps.

Compared with the prior art, the present invention has the several beneficial effects. For instance, in order to achieve better accuracy in the case of the sparse point cloud, the present invention pre-integrates the estimated ego vehicle velocity, to obtain the additional relative pose estimate. Moreover, the present invention introduces the loop closure detection to identify places that have been reached again, thereby optimizing historical poses from a global perspective, to reduce a cumulative drift and implement accurate and robust mapping and localization. Additionally, the present invention uses the 4D millimeter-wave radar to perform accurate and robust synchronous positioning and mapping in an unknown environment.

### BRIEF DESCRIPTION OF DRAWINGS

Other features, objectives, and advantages of the present invention will become more apparent by reading the detailed description of non-limiting embodiments with reference to the following accompanying drawing, in which:
a schematic flowchart of a method is illustrated according to the present invention.

### DETAILED DESCRIPTION OF THE INVENTION

The present invention is described in detail in combination with specific embodiments as below. The following embodiments will help those skilled in the art to further understand the present invention, but do not limit the present invention in any way. It should be noted that a person of ordinary skill in the art may also make several changes and improvements without departing from the concept of the present invention. For example, features illustrated or described as part of one embodiment can be combined with another embodiment to yield still another embodiment. It is intended that the present invention include these and other modifications and variations to the embodiments described herein all belong to the scope of protection of the present invention.

The present invention innovatively proposes a pose graph SLAM algorithm based on a 4D millimeter-wave radar. This algorithm may be applied to manned intelligent wheelchairs, autonomous vehicles, and the like to implement accurate and robust synchronous positioning and mapping tasks.

The present invention provides a pose graph SLAM algorithm based on a 4D millimeter-wave radar. The algorithm includes three modules: a radar point cloud filtering module, an ego vehicle velocity estimation module, and a pose graph optimization module. Aiming at the problem of large noise in a 4D millimeter-wave radar (4D radar) point cloud, a filtering step reduces ghost points and random noise in the original 4D radar point cloud. Next, an ego vehicle velocity is estimated from the Doppler velocity in the filtered point cloud, which plays an important role in subsequent pose graph optimization. In the pose graph optimization, radar odometry is implemented through point cloud registration based on a normal distribution transformation to estimate a relative pose transformation. In order to achieve better accuracy in the case of a sparse point cloud, the estimated ego vehicle velocity is pre-integrated to obtain an additional relative pose estimate. In addition, loop closure detection is introduced to identify places that have been reached again and historical poses are optimized from a global perspective to reduce a cumulative drift and implement accurate and robust mapping and localization.

The pose graph SLAM computation method based on a 4D millimeter-wave radar provided according to the present invention, as shown in the figure, includes a step S1, which includes extracting a ground point cloud and comparing two consecutive frames of point clouds of the 4D radar point cloud to remove ghost points below the ground and random points.

Specifically, in step S1, the ground point cloud is extracted, and the two consecutive frames of point clouds of the 4D radar point cloud are compared to remove ghost points below the ground and unstable random points to reduce noise in the 4D radar point cloud.

Step S1 includes step S1.1: ghost point removal, where the ground point cloud is extracted from an original radar point cloud and the ghost points below the ground are filtered out. For the original radar point cloud [symbol] ={Pᵢ}, i∈{1, 2, . . . , n} measured by a 4D radar, n is a number of points in the point cloud, and a position of each point of the original radar point cloud is expressed in a radar coordinate system as:

$${P}_{i} = {( {x}_{i} , {y}_{i} , {z}_{i} )}^{T} = {( {r}_{i} cos {θ}_{i} cos {φ}_{i} , {r}_{i} sin {θ}_{i} cos {φ}_{i} , {r}_{i} sin {φ}_{i} )}^{T} ,$$

where rᵢ is a distance of the point measured by the 4D radar, θᵢ is an azimuth angle of the point measured by the 4D radar, and o; is an elevation angle of the point measured by the 4D radar. For the original radar point cloud [symbol] , each point with a distance less than a threshold δᵣ and a height within a threshold δₕ near a mounting height of the radar is retained. Moreover, an upward normal vector of each point is computed using a principal component analysis method, and each point with a normal vector having an angle less than &n with a z-axis positive unit vector is retained. Additionally, ground points are extracted using a random sample consensus algorithm, and the ghost points below the ground are filtered out.

Step S1 further includes step S1.2: random point removal, where the random points are identified and filtered out by comparing a current point cloud [symbol] ₖ (e.g., current point cloud frame) and a previous frame of point cloud [symbol] ₖ₋₁ adjacent to the current point cloud such that a pose transformation between the current point cloud and the previous frame of point cloud is computed based on the device velocity. More particularly, the previous frame of point cloud is transformed into a coordinate system of the current frame, and if the transformed previous frame of point cloud does not exist within a preset range near a point in the current frame, the point is classified as a random point and filtered out. A rotation transformation Rₖ₋₁ and a translation transformation tₖ₋₁ between the current point cloud [symbol] ₖ and the previous frame of point cloud Pₖ₋₁ adjacent to the current point cloud are computed according to the following:

$${t}_{k - 1} = {\tilde{v}}_{k - 1} Δ t$$

$${R}_{k - 1} = Exp ( {\tilde{ω}}_{k - 1} Δ t )$$

where νₖ₋₁ and ωₖ₋₁ are respectively a device linear velocity estimate and a device angular velocity estimate of the previous frame Pₖ₋₁, Δt is a time difference between the two frames Pₖ, Pₖ₋₁,. Exp(·): R³→SO(3) is an exponential mapping of a three-dimensional rotation, where R³ is a three-dimensional real number vector space, SO(3) is a three-dimensional special orthogonal group, and Pₖ₋₁ is obtained by transforming the previous frame of point cloud Pₖ₋₁ into the coordinate system of the current frame Pₖ using Rₖ₋₁ and tₖ₋₁. If no point in Pₖ₋₁ exists within a preset range of a current point in the current frame Pₖ, the current point is classified as a random point and filtered out.

The method further includes step S2. Step S2 includes estimating a linear velocity and an angular velocity of a device based on Doppler velocity information in a 4D radar point cloud.

Specifically, step S2 includes step S2.1: static point extraction, where for an i^{th} point in the 4D radar point cloud, a relationship between a Doppler velocity of the point and a velocity of the radar is as follows:

$${v}_{r , i} = - {d}_{i} \cdot {v}_{s}$$

where v_{r,i} is the Doppler velocity of the i^{th} point, dᵢ=(cos θᵢ cos φᵢ, sin θᵢ cos φᵢ, sin φᵢ)^{T} is a unit direction vector of the point relative to the radar, and vs is the velocity of the radar. A relationship between the velocity of the radar and the device velocity is as follows:

$${v}_{s} = {R}_{s}^{T} ( \tilde{v} + \tilde{ω} \times {t}_{s} )$$

where tₛ and Rₛ are respectively a mounting position and a pose of the 4D radar in a device coordinate system, \tilde{ν}∈R³ and \tilde{ω}∈R³ are respectively the linear velocity and the angular velocity of the device, and for all static points in the 4D radar point cloud. The Doppler velocity and the device velocity both conform to the following equation:

$$- [ \begin{matrix}{v}_{r , 1} \\ ⋮ \\ {v}_{r , m}\end{matrix} ] = [ \begin{matrix}{d}_{i}^{T} \\ ⋮ \\ {d}_{m}^{T}\end{matrix} ] = {R}_{s}^{T} [ \begin{matrix}{I}_{3 \times 3} & - {t}_{s}^{\hat{}}\end{matrix} ] [ \begin{matrix}\tilde{v} \\ \tilde{ω}\end{matrix} ] ,$$

where m is a number of all the static points in the point cloud, I_{3×3} is a 3×3 unit matrix, t^{∧}ₛ∈R^{3×3} is an antisymmetric matrix of tₛ, and R^{3×3} represents a set of 3×3 real matrices. Dynamic outliers are removed and the static points are extracted based on relationships between Doppler velocities of all the static points in the radar point cloud and the device velocity using the random sample consensus algorithm.

Step S2 further includes step S2.2: least squares estimation, where after the static points are extracted, the device velocity is computed based on the relationships between the Doppler velocities of all the static points and the device velocity using the least square method.

The method further includes step S3. Step S3 includes estimating and constructing a pose graph using a relative pose transformation that is obtained through point cloud registration performed based on a normal distribution transformation, pre-integration performed using an estimated device velocity, and loop closure detection; and estimating an optimal pose through graph optimization.

Specifically, in step S3, pose graph optimization is performed, where the pose graph is estimated and constructed using the relative pose transformation that is obtained through the point cloud registration, the velocity pre-integration, and the loop closure detection, then the optimal pose is estimated through the graph optimization. Step S3 includes step S3.1: point cloud registration based on the normal distribution transformation, where a relative transformation is estimated by matching between a current 4D radar point cloud and a keyframe submap. Step S3.1 further includes establishing a radar submap using a plurality of keyframe point clouds and a sliding window, where if a translation or rotation from a last keyframe to a current point cloud exceeds a threshold, a current frame is selected as a new keyframe, the new keyframe is added to the radar submap, and when a number of keyframes in the submap exceeds a size of the window, the earliest keyframe is discarded. Additionally, after the radar submap is established, the submap is evenly divided into grids of a same size, a point cloud in each grid is modeled as a local normal distribution, measurement uncertainty of each point is considered when computing a mean and a covariance of the normal distribution, and the current 4D radar point cloud is registered with the radar submap to compute a relative pose transformation that maximizes a distribution probability of the current point cloud in the submap, where an error of estimation of the pose transformation is e_{O}.

Step S3 further includes step S3.2: velocity pre-integration, where the relative pose transformation is computed based on the estimated device velocity, so that an additional reliable relative pose estimate is introduced, and a device linear velocity and a device angular velocity that are estimated at a moment t are respectively denoted as \tilde{ν}ₜ and \tilde{ω}ₜ, with their estimated values being true values each plus a zero-mean Gaussian white noise:

$${\tilde{ω}}_{t} = {ω}_{t} + {η}_{t}^{ω} ,$$

$${\tilde{v}}_{t} = {R}_{tW}^{T} {v}_{t} + {η}_{t}^{v} ,$$

where ωₜ and _{w}vₜ are respectively the true values of the angular velocity and the linear velocity in a world coordinate system, η^{ω}ₜ and η^{ν}ₜ are corresponding noise terms of angular velocity and linear velocity, respectively, and Rₜ is an orientation of the device in the world coordinate system. A relative rotation transformation ΔRᵢⱼ and a relative translation transformation Δpᵢⱼ between a moment i and a moment j are obtained by integration, and an error of estimation of the pose transformation is eᵥ.

Step S3 further includes step S3.3: loop closure detection, where a position that has been previously reached is identified, in polar coordinates, the 4D radar point cloud is divided into grids, a 3D point cloud is mapped to a 2D matrix, where a value of each element in the matrix is a maximum energy intensity of radar points in a corresponding grid. As the device moves, a cosine distance between a 2D matrix of the current frame and a 2D matrix generated by each of all previous keyframes is continuously searched for and computed, and if the distance is less than a set threshold, it is considered that a loop closure has been detected. When a loop closure is detected, a relative pose transformation between the current frame and a submap composed of a loop closure frame and nearby keyframes is computed, and an error of estimation e_{L} of the pose transformation is determined.

Step S3 further includes step S3.4: graph optimization, where the pose graph is established, error terms of relative pose estimates at all moments are considered, optimal poses of the device at all moments are estimated through graph optimization, all nodes in the pose graph correspond to poses at different moments, and edges between the nodes correspond to relative pose transformations between different moments. All the poses are expressed as X={xᵢ}, i∈ [symbol] , and the optimal pose X* is estimated by solving a nonlinear least squares problem:

$${𝒳}^{*} = arg {min}_{𝒳} {e}_{o} + {e}_{V} + {e}_{L}$$

where [symbol] includes all moments, and e_{O}, e_{V}, e_{L} respectively correspond to the errors of relative pose transformations obtained in different steps.

Preferred example aspects are more specifically described below.

The present invention further provides a pose graph SLAM computation system based on a 4D millimeter-wave radar. The pose graph SLAM computation system based on a 4D millimeter-wave radar may be implemented by performing process steps of the pose graph SLAM computation method based on a 4D millimeter-wave radar, that is, those skilled in the art may understand the pose graph SLAM computation method based on a 4D millimeter-wave radar as a preferred implementation of the pose graph SLAM computation system based on a 4D millimeter-wave radar.

The pose graph SLAM computation system based on a 4D millimeter-wave radar provided according to the present invention includes a module M1, a module M2, and a module M3.

The module M1 is configured to extract a ground point cloud, then compare two consecutive frames of point clouds, to remove ghost points below the ground and random points. Specifically, in the module M1, the ground point cloud is extracted, and the two consecutive frames of point clouds are compared, to remove the ghost points below the ground and the unstable random points, so as to reduce noise in the 4D radar point cloud. A module M1.1 of module M1 is configured to perform ghost point removal, where the ground point cloud is extracted from an original radar point cloud and the ghost points below the ground are filtered out. For instance, for the original radar point cloud [symbol] ={Pᵢ}, i∈{1, 2, . . . , n} measured by a 4D radar, n is a number of points in the point cloud, and a position of each point in a radar coordinate system is expressed as:

$${P}_{i} = {( {x}_{i} , {y}_{i} , {z}_{i} )}^{T} = {( {r}_{i} cos {θ}_{i} cos {φ}_{i} , {r}_{i} sin {θ}_{i} cos {φ}_{i} , {r}_{i} sin {φ}_{i} )}^{T} ,$$

where rᵢ is a distance of the point measured by the 4D radar, θᵢ is an azimuth angle of the point measured by the 4D radar, and o; is an elevation angle of the point measured by the 4D radar. For the original radar point cloud, a point with a distance less than a threshold δᵣ and a height within a threshold δₕ near a mounting height of the radar is retained. Further, an upward normal vector of each point is computed using a principal component analysis method, a point with a normal vector having an angle less than δₙ with a z-axis positive unit vector is retained. Additionally, ground points are extracted using a random sample consensus algorithm, and the ghost points below the ground are filtered out.

A module M1.2 of module M1 is configured to perform random point removal, where the random points are identified and filtered out by comparing a current point cloud and a previous frame of point cloud adjacent to the current point cloud, then a pose transformation between the current point cloud and the previous frame of point cloud is computed based on the device velocity. Particularly, the previous frame of point cloud is transformed into a coordinate system of the current frame, and if the transformed previous frame of point cloud does not exist within a preset range near a point in the current frame, the point is classified as a random point and filtered out.

More particularly, a rotation transformation Rₖ₋₁ and a translation transformation tₖ₋₁ between the current point cloud [symbol] ₖ and the previous frame of point cloud [symbol] ₖ₋₁ adjacent to the current point cloud are computed:

$${t}_{k - 1} = {\tilde{v}}_{k - 1} Δ t$$

$${R}_{k - 1} = Exp ( {\tilde{ω}}_{k - 1} Δ t )$$

where \tilde{ν}ₖ₋₁ and \tilde{ω}ₖ₋₁ are respectively a device linear velocity estimate and a device angular velocity estimate of the previous frame, and Δt is a time difference between the two frames. Exp(·): R³→SO(3) is an exponential mapping of a three-dimensional rotation, R³ is a three-dimensional real number vector space, SO(3) is a three-dimensional special orthogonal group, and [symbol] ₖ₋₁′ is obtained by transforming the previous frame of point cloud into the coordinate system of the current frame using Rₖ₋₁ and tₖ₋₁. If no point in [symbol] ₖ₋₁′ exists within a preset range of a point in the current frame, the current point is classified as a random point and filtered out.

The module M2 is configured to estimate a linear velocity and an angular velocity of a device based on Doppler velocity information in a 4D radar point cloud. Specifically, in the module M2, a module M2.1 is configured to perform static point extraction, where for an i^{th} point in the 4D radar point cloud, a relationship between a Doppler velocity of the point and a velocity of the radar is as follows:

$${v}_{r , i} = - {d}_{i} \cdot {v}_{s}$$

where v_{r,i} is the Doppler velocity of the i^{th} point, dᵢ=(cos θᵢ cos φᵢ, sin θᵢ cos φᵢ, sin φᵢ) T is a unit direction vector of the point relative to the radar, and vs is the velocity of the radar. A relationship between the velocity of the radar and the device velocity is as follows:

$${ν}_{s} = {R}_{s}^{T} ( \tilde{ν} + \tilde{ω} \times {t}_{s} )$$

where tₛ and Rₛ are respectively a mounting position and a pose of the 4D radar in a device coordinate system, and \tilde{ν}∈R³ and \tilde{ω}∈R³ are respectively the linear velocity and the angular velocity of the device. For all static points in the 4D radar point cloud, the Doppler velocity and the device velocity both conform to the following equation:

$$- [ \begin{matrix}{v}_{r - 1} \\ ⋮ \\ {v}_{r , m}\end{matrix} ] = [ \begin{matrix}{d}_{i}^{T} \\ ⋮ \\ {d}_{m}^{T}\end{matrix} ] {R}_{s}^{T} [ \begin{matrix}{I}_{3 \times 3} & - {t}_{s}^{∧}\end{matrix} ] [ \begin{matrix}\tilde{v} \\ \tilde{ω}\end{matrix} ] ,$$

where m is a number of all the static points in the point cloud, I_{3×3} is a 3×3 unit matrix, tₛ E R^{3×3} is an antisymmetric matrix of tₛ, and R^{3×3} represents a set of 3×3 real matrices. Dynamic outliers are removed and the static points are extracted based on relationships between Doppler velocities of all the static points in the radar point cloud and the device velocity using the random sample consensus algorithm.

A module M2.2 of module M2 is configured to perform least squares estimation, where after the static points are extracted, the device velocity is computed based on the relationships between the Doppler velocities of all the static points and the device velocity using the least square method.

The module M3 is configured to estimate and construct a pose graph using a relative pose transformation that is obtained through point cloud registration performed based on a normal distribution transformation, pre-integration performed using an estimated device velocity, and loop closure detection, then estimate an optimal pose through graph optimization. Specifically, in the module M3, pose graph optimization is performed, where the pose graph is estimated and constructed using the relative pose transformation that is obtained through the point cloud registration, the velocity pre-integration, and the loop closure detection, and finally the optimal pose is estimated through the graph optimization.

A module M3.1 of module M3 is configured to perform point cloud registration based on the normal distribution transformation, where a relative transformation is estimated by matching between a current 4D radar point cloud and a keyframe submap. A radar submap is established using a plurality of keyframe point clouds and a sliding window. If a translation or rotation from a last keyframe to a current point cloud exceeds a threshold, a current frame is selected as a new keyframe, the new keyframe is added to the radar submap, and when a number of keyframes in the submap exceeds a size of the window, the earliest keyframe is discarded. After the radar submap is established, the submap is evenly divided into grids of a same size, a point cloud in each grid is modeled as a local normal distribution, measurement uncertainty of each point is considered when computing a mean and a covariance of the normal distribution, and the current 4D radar point cloud is registered with the radar submap to compute a relative pose transformation that maximizes a distribution probability of the current point cloud in the submap, where an error of estimation e_{O} of the pose transformation is determined.

A module M3.2 of module M3 is configured to perform velocity pre-integration, where the relative pose transformation is computed based on the estimated device velocity, so that an additional reliable relative pose estimate is introduced, and a device linear velocity and a device angular velocity that are estimated at a moment t are respectively denoted as \tilde{ν}ₜ and \tilde{ω}ₜ, with their estimated values being true values each plus a zero-mean Gaussian white noise:

$${\tilde{ω}}_{t} = {ω}_{t} + {η}_{t}^{ω} ,$$

$${\tilde{v}}_{t} = {R}_{t}^{T} {}_{W} {v}_{t} + {η}_{t}^{v} ,$$

where ωₜ and _{w}Vₜ are respectively the true values of the angular velocity and the linear velocity in a world coordinate system, η^{ω}ₜ and η^{ν}ₜ are corresponding noise terms, and Rₜ is an orientation of the device in the world coordinate system. A relative rotation transformation ΔRᵢⱼ and a relative translation transformation Δpᵢⱼ between a moment i and a moment j are obtained by integration, and an error of estimation e_{V} of the pose transformation is determined.

Specifically, a module M3.3 of module M3 is configured to perform loop closure detection, where a position that has been previously reached is identified, in polar coordinates, the 4D radar point cloud is divided into grids, a 3D point cloud is mapped to a 2D matrix, and a value of each element in the matrix is a maximum energy intensity of radar points in a corresponding grid. As the device moves, a cosine distance between a 2D matrix of the current frame and a 2D matrix generated by each of all previous keyframes is continuously searched for and computed, and if the distance is less than a set threshold, it is considered that a loop closure has been detected. When a loop closure is detected, a relative pose transformation between the current frame and a submap composed of a loop closure frame and nearby keyframes is computed, and an error of estimation e of the pose transformation is determined.

A module M3.4 of the module M3 is configured to perform graph optimization, where the pose graph is established, error terms of relative pose estimates at all moments are considered, optimal poses of the device at all moments are estimated through graph optimization, all nodes in the pose graph correspond to poses at different moments, and edges between the nodes correspond to relative pose transformations between different moments. All the poses are expressed as X={xᵢ}, i∈ [symbol] , and the optimal pose X* is estimated by solving a nonlinear least squares problem:

$${𝒳}^{*} = arg {min}_{𝓍} {e}_{O} + {e}_{V} + {e}_{L}$$

where [symbol] includes all moments, and e_{O}, e_{V}, e_{L} respectively correspond to the errors of relative pose transformations obtained in different steps.

Further preferred example aspects are more specifically below.

In view of the shortcomings of the existing technology, this specification innovatively proposes a pose graph SLAM algorithm based on a 4D millimeter-wave radar, which is suitable for the synchronous positioning and mapping issue of vehicles or mobile robots in an unknown environment.

The pose graph SLAM algorithm based on a 4D millimeter-wave radar provided according to the present invention mainly includes the following steps 1-3. Particularly, step 1 includes radar point cloud filtering when an original 4D radar point cloud mainly contains two types of noise: ghost points and random points. More particularly, a ground point cloud is extracted, and two consecutive frames of point clouds are compared to remove ghost points below the ground and unstable random points to reduce noise in the 4D radar point cloud. Step 2 includes ego vehicle velocity estimation, where a 4D millimeter-wave radar obtains a Doppler velocity of each point, where the Doppler velocity is a radial component of a relative velocity between the radar and a target point, then a linear velocity and an angular velocity of an ego vehicle are estimated based on Doppler velocity information in a 4D radar point cloud. Step 3 includes pose graph optimization, where a current radar point cloud is registered with a local radar keyframe submap based on a normal distribution transformation, so as to obtain a radar odometry factor; pre-integration is performed using an estimated ego vehicle velocity, so as to obtain a velocity pre-integration factor; and loop closure detection is performed to obtain a loop closure factor. Finally, the three factors (radar odometry, velocity pre-integration factor, and loop closure factor) are used to construct a pose graph, and an optimal pose is estimated based on graph optimization.

Specifically, the radar point cloud filtering process in step 1 mainly includes the following steps. In step 1.1 of step 1, ghost point removal is performed, where ghost points are false measurements below the ground in the original 4D radar point cloud caused by the multipath effect of millimeter waves, and they are one of 4D radar measurement noises. The ground point cloud is extracted from the original radar point cloud and then the ghost points below the ground are filtered out.

For the original radar point cloud [symbol] ={Pᵢ}, i∈{1, 2, . . . , n} obtained by the 4D radar, n is a number of points in the point cloud, a position of each point in a radar coordinate system may be expressed as:

$${P}_{i} = {( {x}_{i} , {y}_{i} , {z}_{i} )}^{T} = {( {r}_{i} cos {θ}_{i} cos {φ}_{i} , {r}_{i} sin {θ}_{i} cos {φ}_{i} , {r}_{i} sin {φ}_{i} )}^{T} ,$$

and rᵢ, θᵢ, φᵢ are spatial information of the point measured by the 4D radar: a distance, an azimuth angle, and an elevation angle. For the original radar point cloud, a point with a distance less than a threshold δᵣ and a height within a threshold δₕ near a mounting height H of the radar is first retained, that is, for all Pᵢ∈ [symbol] ₖ, points that meet

$$\sqrt{{x}_{i}^{2} + {y}_{i}^{2} + {z}_{i}^{2}} \leq {δ}_{r}$$

and zᵢ∈[−H−Δₕ, −H+Δₕ] are retained, because these points are most likely to belong to the ground. Then, an upward normal vector nᵢ of each point is estimated using a principal component analysis method. Next, a point with a normal vector having an angle less than δₙ with a z-axis positive unit vector is retained, that is, a point that meets nᵢ·(0,0,1)^{T}≥cos δₙ is retained. Finally, a plane Ax+By+Cz+D=0 is extracted using a random sample consensus algorithm, the plane is considered as the ground, and the ghost points below the ground are filtered out, that is, points that meet Axᵢ+Byᵢ+Czᵢ+D<0 are filtered out.

In step 1.2 of step 1, random point removal is performed, where random points are unstable and flickering false measurements contained in the original 4D radar point cloud, and are one of the measurement noises of the 4D radar. Since random points do not appear continuously in a plurality of consecutive frames of radar point clouds, random points are identified and filtered out by comparing a current point cloud and a previous frame of point cloud adjacent to the current point cloud.

First, a rotation transformation Rₖ₋₁ and a translation transformation tₖ₋₁ between the current point cloud [symbol] ₖ and the previous frame of point cloud [symbol] ₖ₋₁ adjacent to the current point cloud are computed:

$${t}_{k - 1} = {\tilde{v}}_{k - 1} Δ t ,$$

$${R}_{k - 1} = Exp ( {\tilde{ω}}_{k - 1} Δ t ) ,$$

where \tilde{ν}ₖ₋₁ and \tilde{ω}ₖ₋₁ are respectively an ego vehicle linear velocity estimate and an ego vehicle angular velocity estimate of the previous frame, Δt is a time difference between the two frames, and Exp(·): R³→SO(3) is an exponential mapping of a three-dimensional rotation (R³ is a three-dimensional real number vector space, and SO(3) is a three-dimensional special orthogonal group). Then, [symbol] ₖ₋₁ is obtained by transforming the previous frame of point cloud into the coordinate system of the current frame using Rₖ₋₁ and tₖ₋₁. If no point in [symbol] ₖ₋₁ exists near a point in the current frame, the current point is classified as a random point and filtered out.

Specifically, the ego vehicle velocity estimation process in step 2 mainly includes the following steps.

In step 2.1 of step 2, static point extraction is performed. In addition to spatial information, the 4D radar also obtains a Doppler velocity of each point in the point cloud. For an i^{th} point in the 4D radar point cloud, if it is a stationary point with an absolute velocity of 0 in the real world, then its relative velocity to the radar is equal in magnitude and opposite in direction to the velocity of the radar. The Doppler velocity is a radial component of a relative velocity between the measured point and the 4D radar. Therefore, a relationship between the Doppler velocity of this point and the velocity of the radar is as follows:

$${v}_{r , i} = - {d}_{i} \cdot {v}_{s} ,$$

where v_{r,i} is the Doppler velocity of the i^{th} point, dᵢ=(cos θᵢ cos φᵢ, sin θᵢ cos φᵢ, sin φᵢ)^{T} is a unit direction vector of the point relative to the radar, and vs is the velocity of the radar.

In addition, since the 4D radar is mounted on a vehicle, a relationship between the velocity of the radar and an ego vehicle velocity of the vehicle is as follows:

$${v}_{s} = {R}_{s}^{T} ( \tilde{v} + \tilde{ω} \times {t}_{s} ) ,$$

where tₛ and Rₛ are respectively a mounting position and a pose of the 4D radar in a vehicle coordinate system, and \tilde{ν}∈R³ and \tilde{ω}∈R³ are respectively an ego vehicle linear velocity and an ego vehicle angular velocity. In the real world, most points in the 4D radar point cloud are static points. Therefore, for all static points in the 4D radar point cloud, the Doppler velocity and the ego vehicle velocity both conform to the following equation:

$$- [ \begin{matrix}{v}_{r , 1} \\ ⋮ \\ {v}_{r , m}\end{matrix} ] = [ \begin{matrix}{d}_{i}^{T} \\ ⋮ \\ {d}_{m}^{T}\end{matrix} ] {R}_{s}^{T} [ \begin{matrix}{I}_{3 \times 3} & - {t}_{s}^{\hat{}}\end{matrix} ] [ \begin{matrix}\tilde{v} \\ \tilde{ω}\end{matrix} ] ,$$

where m is a number of all the static points in the point cloud, I_{3×3} is a 3×3 unit matrix, and t E R^{3×3} is an antisymmetric matrix of tₛ (R^{3×3} represents a set of 3×3 real matrices). Dynamic outliers are removed and the static points are extracted based on relationships between Doppler velocities of all the static points in the radar point cloud and the ego vehicle velocity using the random sample consensus algorithm.

In step 2.2 of step 2, least squares estimation is performed, where after the static points are extracted, the ego vehicle velocity is estimated based on the relationships between the Doppler velocities of all the static points and the ego vehicle velocity again using the least square method.

Specifically, the pose graph optimization process in step 3 mainly includes the following steps.

In step 3.1 of step 3, point cloud registration is performed based on the normal distribution transformation, where the relative transformation is estimated by direct matching between a current 4D radar point cloud and a keyframe submap.

When the 4D radar point cloud is too sparse, it is impossible to correctly estimate a pose only by matching of a single frame of point cloud. Therefore, a sliding window method is used to establish a denser radar submap using a plurality of keyframe point clouds. Specifically, if a translation or rotation from a last keyframe to a current point cloud exceeds a threshold, a current frame is selected as a new keyframe. Then, the new keyframe is added to the radar submap, and a node associated with the keyframe is added to the pose graph. When a number of keyframes in the submap exceeds a size of the window, the earliest keyframe is discarded. The radar submap established through this method reflects local environmental features more clearly than a single frame of radar point cloud, improving the accuracy and robustness of point cloud registration.

After the radar submap is established, the submap is evenly divided into grids of a same size, and a point cloud in each grid is modeled as a local normal distribution. Due to the highly sparse 4D radar point cloud, a case where there are less than three points in a grid or points in the grid are collinear (coplanar) may easily occur after grid division, making it difficult to invert the covariance of the normal distribution. Therefore, measurement uncertainty of each point is comprehensively considered when computing a mean and a covariance of the normal distribution. An advantage of this is to reduce the degeneration effect of covariance, and point cloud information in a grid is fully used even when there are very few points in the grid. Then, the current 4D radar point cloud is registered with the radar submap to estimate a relative pose transformation that maximizes a distribution probability of the current point cloud in the submap, and the relative pose transformation is added to the pose graph as a radar odometry factor. An error of estimation e_{O} of the pose transformation is determined.

In step 3.2 of step 3, velocity pre-integration is performed, where the relative pose transformation is computed using the estimated ego vehicle velocity so that an additional reliable relative pose estimate is introduced, which improves the accuracy and robustness of SLAM. An ego vehicle linear velocity and an ego vehicle angular velocity that are estimated at a moment t are respectively denoted as \tilde{ν}ₜ and \tilde{ω}ₜ, with their estimated values being true values each plus a zero-mean Gaussian white noise, that is:

$${\tilde{ω}}_{t} = {ω}_{t} + {η}_{t}^{ω} , \\ {\tilde{v}}_{t} = {R}_{t}^{T} {}_{W} {v}_{t} + {η}_{t}^{v} ,$$

where ωₜ and _{w}Vₜ are respectively the true values of the angular velocity and the linear velocity in a world coordinate system, η^{ω}ₜ and η^{ν}ₜ are corresponding noise terms, and Rₜ is an orientation of the vehicle in the world coordinate system. From this, a relative rotation transformation ΔRᵢⱼ and a relative translation transformation Δpᵢⱼ between a moment i and a moment j are obtained:

$$Δ {R}_{ij} = {R}_{i}^{T} {R}_{j} = {\prod }_{k = i}^{j - 1} Exp ( ( {\tilde{ω}}_{k} - {η}_{k}^{ω} ) Δ t ) = {\underbrace{{\prod }_{k = i}^{j - 1} Exp ( {\tilde{ω}}_{k} Δ t )}}_{Δ {\tilde{R}}_{ij}} {\underbrace{{\prod }_{k = i}^{j - 1} Exp ( - Δ {\tilde{R}}_{k + 1 , j}^{T} {J}_{r , k} {η}_{k}^{ω} Δ t )}}_{Exp ( - {δφ}_{ij} )} \\ Δ {p}_{ij} = {R}_{i}^{T} ( {p}_{j} - {p}_{i} ) = {\sum }_{k = i}^{j - 1} Δ {R}_{ik} ( {\tilde{v}}_{k} - {η}_{k}^{v} ) Δ t = {\underbrace{{\sum }_{k = i}^{j - 1} Δ {\tilde{R}}_{ik} {\tilde{v}}_{k} Δ t}}_{Δ {\tilde{p}}_{ij}} - {\underbrace{{\sum }_{k = i}^{j - i} \{ ( - Δ {\tilde{R}}_{ik} {\tilde{v}}_{k}^{\hat{}} {δφ}_{ik} Δ t ) + Δ {\tilde{R}}_{ik} {η}_{k}^{v} Δ t \}}}_{δ {p}_{ij}}$$

where ΔRᵢₖ=R^{T}ᵢRₖ, J_{r,k} is a right Jacobian matrix of \tilde{ω}ₖΔt, \tilde{ν}^{Δ}ₖ is an antisymmetric matrix of a vector \tilde{ν}ₖ, ΔRᵢⱼ and Δpᵢⱼ are respectively a relative rotation and a relative translation obtained by ego vehicle velocity pre-integration, and are added to the pose graph as a velocity pre-integration factor between nodes corresponding to moments i and j, and δφᵢⱼ and δφᵢⱼ are corresponding noises. An error of estimation e_{V} of the pose transformation is determined.

In step 3.3 of step 3, loop closure detection is performed to identify places that have been previously reached, so as to reduce a cumulative drift. In polar coordinates, the 4D radar point cloud is divided into grids, a 3D point cloud is mapped to a 2D matrix, and a value of each element in the matrix is a maximum energy intensity of radar points in a corresponding grid. As the vehicle moves, a cosine distance between a 2D matrix of the current frame and a 2D matrix generated by each of all previous keyframes is continuously searched for and computed, and if the distance is less than a set threshold, it is considered that a loop closure has been detected. Once a loop closure is detected, a relative pose transformation between the current frame and a submap composed of a loop closure frame and nearby keyframes is computed using the registration method introduced in the point cloud registration step. An error of estimation e_{L} of the pose transformation is determined.

In step 3.4 of step 3, graph optimization is performed, where the pose graph is established, error terms of relative pose estimates at all moments are comprehensively considered, and optimal poses of the ego vehicle at all moments are estimated through graph optimization. All nodes in the pose graph correspond to poses at different moments, and edges between the nodes correspond to relative pose transformations between different moments. All the poses are expressed as X={xᵢ}, i∈ [symbol] , and the optimal pose X* is estimated by solving a nonlinear least squares problem:

$${𝒳}^{*} = arg {min}_{𝒳} {e}_{O} + {e}_{V} + {e}_{L} ,$$

where [symbol] includes all moments, and e_{O}, e_{V}, e_{L} respectively correspond to the errors of relative pose transformations obtained in different steps.

In a specific implementation process, as shown in the figure, the present invention is divided into three parts: (1) radar point cloud filtering, (2) ego vehicle velocity estimation, and (3) pose graph optimization.

In step 1, radar point cloud filtering is performed, where the original 4D radar point cloud mainly contains two types of noise: ghost points and random points. The ground point cloud is extracted, and the two consecutive frames of point clouds of the original 4D radar point cloud are compared to remove the ghost points below the ground and the unstable random points, so as to reduce noise in the 4D radar point cloud.

In step 1.1, ghost point removal is performed, where ghost points are false measurements below the ground in the original 4D radar point cloud caused by the multipath effect of millimeter waves, and they are one of the 4D radar measurement noises. The ground point cloud is extracted from the original radar point cloud and then the ghost points below the ground are filtered out.

For the original radar point cloud [symbol] ={Pᵢ}, i∈{1, 2, . . . , n} obtained by the 4D radar, n is a number of points in the point cloud, a position of each point in a radar coordinate system may be expressed as Pᵢ=(xᵢ, yᵢ, zᵢ)^{T}=(rᵢ cos θᵢ cos φᵢ, rᵢ sin θᵢ cos φᵢ, rᵢ sin φᵢ)^{T}, and rᵢ, θᵢ, φᵢ are spatial information of the point measured by the 4D radar: a distance, an azimuth angle, and an elevation angle. For the original radar point cloud, a point with a distance less than a threshold 8, and a height within a threshold δₕ near a mounting height H of the radar is first retained, that is, all Pᵢ∈ [symbol] ₖ, points that meet

$$\sqrt{{x}_{i}^{2} + {y}_{i}^{2} + {z}_{i}^{2}} \leq {δ}_{r}$$

and zᵢ∈[−H−δₕ, −H+δₕ] are retained, because these points are most likely to belong to the ground. Then, an upward normal vector n; of each point is estimated using a principal component analysis method. Next, a point with a normal vector having an angle less than δₙ with a z-axis positive unit vector is retained, that is, a point that meets nᵢ·(0,0,1)^{T}>cos δₙ is retained. Finally, a plane Ax+By+Cz+D=0 is extracted using a random sample consensus algorithm, the plane is considered as the ground, and the ghost points below the ground are filtered out, that is, points that meet Axᵢ+Byᵢ+Czᵢ+D<0 are filtered out.

In step 1.2, random point removal is performed, where random points are unstable, flickering false measurements contained in the original 4D radar point cloud, and are one of the measurement noises of the 4D radar. Since random points do not appear continuously in a plurality of consecutive frames of radar point clouds, random points are identified and filtered out by comparing a current point cloud and a previous frame of point cloud adjacent to the current point cloud.

First, a rotation transformation Rₖ₋₁ and a translation transformation tₖ₋₁ between the current point cloud [symbol] ₖ and the previous frame of point cloud [symbol] ₖ₋₁ adjacent to the current point cloud are computed:

$${t}_{k - 1} = {\tilde{v}}_{k - 1} Δ t ,$$

$${R}_{k - 1} = Exp ( {\tilde{ω}}_{k - 1} Δ t ) ,$$

where \tilde{ν}ₖ₋₁ and \tilde{ω}ₖ₋₁ are respectively an ego vehicle linear velocity estimate and an ego vehicle angular velocity estimate of the previous frame, Δt is a time difference between the two frames, and Exp(·): R³→SO(3) is an exponential mapping of a three-dimensional rotation (R³ is a three-dimensional real number vector space, and SO(3) is a three-dimensional special orthogonal group). Then, the transformed previous frame of point cloud [symbol] ₖ₋₁ is obtained by transforming the previous frame of point cloud into the coordinate system of the current frame using Rₖ₋₁ and tₖ₋₁. Next, a KD tree is constructed using [symbol] ₖ₋₁, so as to implement nearest neighbor search. If no point in [symbol] ₖ₋₁ exists within a specific range of a point in the current point cloud [symbol] ₖ, the current point is classified as a random point and filtered out.

In step 2, ego vehicle velocity estimation is performed, where the 4D millimeter-wave radar obtains a Doppler velocity of each point, and the Doppler velocity is a radial component of a relative velocity between the radar and a target point. Based on the property of the Doppler velocity, a linear velocity and an angular velocity of an ego vehicle are estimated based on Doppler velocity information in a 4D radar point cloud.

In step 2.1, static point extraction is performed. In addition to spatial information, the 4D radar also obtains a Doppler velocity of each point in the point cloud. For an i^{th} point in the 4D radar point cloud, if it is a stationary point with an absolute velocity of 0 in the real world, then its relative velocity to the radar is equal in magnitude and opposite in direction to the velocity of the radar. The Doppler velocity is a radial component of a relative velocity between the measured point and the 4D radar. Therefore, a relationship between the Doppler velocity of this point and the velocity of the radar is as follows:

$${v}_{r , i} = - {d}_{i} \cdot {v}_{s} ,$$

where v_{r,i} is the Doppler velocity of the i^{th} point, dᵢ=(cos θᵢ cos φᵢ, sin θᵢ cos φᵢ, sin φᵢ)^{T} is a unit direction vector of the point relative to the radar, and vs is the velocity of the radar.

In addition, since the 4D radar is mounted on a vehicle, a relationship between the velocity of the radar and an ego vehicle velocity of the vehicle is as follows:

$${v}_{s} = {R}_{s}^{T} ( \tilde{v} + \tilde{ω} \times {t}_{s} ) ,$$

where tₛ and Rₛ are respectively a mounting position and a pose of the 4D radar in a vehicle coordinate system, and \tilde{ν}∈R³ and \tilde{ω}∈R³ are respectively an ego vehicle linear velocity and an ego vehicle angular velocity. In the real world, most points in the 4D radar point cloud are static points. Therefore, for all static points in the 4D radar point cloud, the Doppler velocity and the ego vehicle velocity both conform to the following equation:

$$- [ \begin{matrix}{v}_{r , 1} \\ ⋮ \\ {v}_{r , m}\end{matrix} ] = [ \begin{matrix}{d}_{i}^{T} \\ ⋮ \\ {d}_{m}^{T}\end{matrix} ] {R}_{s}^{T} [ \begin{matrix}{I}_{3 \times 3} & - {t}_{s}^{∧}\end{matrix} ] [ \begin{matrix}\tilde{v} \\ \tilde{ω}\end{matrix} ] ,$$

where m is a number of all the static points in the point cloud, I_{3×3} is a 3×3 unit matrix, and t^{∧}ₛ∈R^{3×3} is an antisymmetric matrix of tₛ (R^{3×3} represents a set of 3×3 real matrices). Since relationships between Doppler velocities of dynamic points and the ego vehicle velocity do not conform to the equation described above, dynamic outliers are removed using the random sample consensus algorithm, and the static points are extracted.

In step 2.2, least squares estimation is performed, where after the static points are extracted, the ego vehicle velocity is estimated based on the relationships between the Doppler velocities of all the static points and the ego vehicle velocity again and the least square method.

In step 3, pose graph optimization is performed, where a current radar point cloud is registered with a local radar keyframe submap based on a normal distribution transformation, so as to obtain a millimeter-wave radar odometry factor; pre-integration is performed using the estimated ego vehicle velocity, so as to obtain a velocity pre-integration factor; and loop closure detection is performed to obtain a loop closure factor. Finally, the three factors are used to construct a pose graph, and an optimal pose is estimated based on graph optimization.

In step 3.1, point cloud registration is performed based on the normal distribution transformation, where the relative transformation is estimated by direct matching between a current 4D radar point cloud and a keyframe submap.

When the 4D radar point cloud is too sparse, it is impossible to correctly estimate a pose only by matching of a single frame of point cloud. Therefore, a sliding window method is used to establish a denser radar submap using a plurality of keyframe point clouds. Specifically, if a translation or rotation from a last keyframe to a current point cloud exceeds a threshold, a current frame is selected as a new keyframe. Then, the new keyframe is added to the radar submap, and a node associated with the keyframe is added to the pose graph. When a number of keyframes in the submap exceeds a size of the window, the earliest keyframe is discarded. The radar submap established through this method reflects local environmental features more clearly than a single frame of radar point cloud, improving the accuracy and robustness of point cloud registration.

After the radar submap is established, the submap is evenly divided into grids of a same size, and a point cloud in each grid is modeled as a local normal distribution. Due to the sparsity of the 4D radar point cloud, a case where there are less than three points in a grid or points in the grid are collinear (coplanar) may easily occur after grid division, making it difficult to invert the covariance of the normal distribution. Therefore, measurement uncertainty of each point is comprehensively considered when computing a mean and a covariance of the normal distribution. An advantage of this is to reduce the degeneration effect of covariance, and point cloud information in a grid is fully used even when there are very few points in the grid. Then, the current 4D radar point cloud is registered with the radar submap to estimate a relative pose transformation \tilde{x}⁰ᵢⱼ that maximizes a distribution probability of the current point cloud in the submap, and the relative pose transformation is added to the pose graph as a radar odometry factor between nodes corresponding to moments i and j. An error of estimation of the pose transformation is e_{O}, in a form as follows:

$${e}_{0} = {\sum }_{( i , j ) ∈ 𝒦} {‖ Log ( {( {\tilde{x}}_{ij}^{0} )}^{- 1} {{x}_{i}}^{- 1} {x}_{j} ) ‖}_{{\sum }_{ij}^{0}}^{2}$$

where Σ⁰ᵢⱼ is a corresponding covariance matrix, Log (·): SE(3)→R⁶ is a logarithmic mapping (SE(3) is a three-dimensional special Euclidean group, and R⁶ is a six-dimensional real number vector space) of a three-dimensional transformation.

In step 3.2, velocity pre-integration is performed, where the relative pose transformation is computed using the estimated ego vehicle velocity, so that an additional reliable relative pose estimate is introduced, improving the accuracy and robustness of SLAM. An ego vehicle linear velocity and an ego vehicle angular velocity that are estimated at a moment t are respectively denoted as t and @t, with their estimated values being true values each plus a zero-mean Gaussian white noise, that is:

$${\tilde{ω}}_{t} = {ω}_{t} + {η}_{t}^{ω} ,$$

$${\tilde{ν}}_{t} = {R}_{t}^{T} {}_{W} {ν}_{t} + {η}_{t}^{v} ,$$

where ωₜ and _{w}Vₜ are respectively the true values of the angular velocity and the linear velocity in a world coordinate system, η^{ω}ₜ and η^{ν}ₜ are corresponding noise terms, and Rₜ is an orientation of the vehicle in the world coordinate system. Assuming that ωₜ and _{w}Vₜ remains unchanged within a very short period of time [t,t+Δt], a position P_{t+Δt} and a rotation R_{t+Δt} at a moment t+Δt are computed based on a position pₜ and a rotation Rₜ at a moment t:

$${R}_{t + Δ t} = {R}_{t} Exp ( {ω}_{t} Δ t ) = {R}_{t} Exp ( ( {\tilde{ω}}_{k} - {η}_{k}^{ω} ) Δt ) ,$$

$${P}_{t + Δ t} = {p}_{t} + {}_{W} {ν}_{t} Δ t = {p}_{t} + {R}_{t} ( {\tilde{ν}}_{t} - {η}_{t}^{v} ) Δ t .$$

For a point cloud of each frame between keyframes corresponding to two consecutive moments i and j, an ego vehicle velocity estimate is obtained. Therefore, integration is performed for all time periods Δt between moments i and j, and a position p; and a rotation Rⱼ at a moment j are computed based on a position pᵢ and a rotation Rⱼ at a moment i.

$${R}_{j} = {R}_{i} {\prod }_{k = i}^{j - 1} Exp ( ( {\tilde{ω}}_{k} - {η}_{k}^{ω} ) Δ t )$$

$${p}_{j} = {p}_{i} + {\sum }_{k = i}^{j - i} {R}_{k} ( {\tilde{v}}_{k} - {η}_{k}^{v} ) Δ t$$

From this, a relative rotation transformation ΔRᵢⱼ and a relative translation transformation Δpᵢⱼ between a moment i and a moment j are obtained:

$$Δ {R}_{i j} = {R}_{i}^{T} {R}_{j} = {\prod }_{k = i}^{j - 1} Exp ( ( {\tilde{ω}}_{k} - {η}_{k}^{ω} ) Δ t ) = {\underbrace{{\prod }_{k = i}^{j - 1} Exp ( {\tilde{ω}}_{k} Δ t )}}_{Δ {\tilde{R}}_{i j}} {\underbrace{{\prod }_{k = i}^{j - 1} Exp ( - Δ {\tilde{R}}_{k + 1 , j}^{T} {J}_{r , k} {η}_{k}^{ω} Δ t )}}_{Exp ( - δ {ϕ}_{i j} )}$$

$$Δ {p}_{i j} = {R}_{i}^{T} ( {p}_{j} - {p}_{i} ) = {\sum }_{k = i}^{j - 1} Δ {R}_{i k} ( {\tilde{v}}_{k} - {η}_{k}^{v} ) Δ t = {\underbrace{{\sum }_{k = i}^{j - 1} Δ {\tilde{R}}_{i k} {\tilde{v}}_{k} Δ t}}_{Δ {\tilde{p}}_{i j}} {\underbrace{{\sum }_{k = i}^{j - i} \{ ( - Δ {\tilde{R}}_{i k} {\tilde{v}}_{k}^{⋀} {δϕ}_{i k} Δ t ) + Δ {\tilde{R}}_{i k} {η}_{k}^{v} Δ t \}}}_{δ {p}_{i j}}$$

where ΔRᵢₖ=R^{T}ᵢRₖ, J_{r,k} is a right Jacobian matrix of \tilde{ω}ₖΔt, \tilde{ν}^{∧}ₖ is an antisymmetric matrix of a vector \tilde{ν}ₖ, ΔRᵢⱼ and Δpᵢⱼ are respectively a relative rotation and a relative translation obtained by ego vehicle velocity pre-integration, and are added to the pose graph as a velocity pre-integration factor between nodes corresponding to moments i and j. δφᵢⱼ and δφᵢⱼ are corresponding noises, in a form as follows:

$${δφ}_{ij} = {\sum }_{k = i}^{j - 1} Δ {\tilde{R}}_{k + 1 , j}^{T} {J}_{r , k} {η}_{k}^{ω} Δ t$$

$$δ {p}_{ij} = {\sum }_{k = i}^{j - 1} ( - Δ {\tilde{R}}_{ik} {\tilde{v}}_{k}^{⋀} {Δφ}_{ik} Δ t + Δ {\tilde{R}}_{ik} {η}_{k}^{v} Δ t ) .$$

Because δϕᵢⱼ is a linear combination of a zero-mean Gaussian noise η^{ω}ₖ, δϕᵢⱼ is a zero-mean Gaussian noise. Similarly, δϕᵢⱼ is a zero-mean Gaussian noise because it is a linear combination of zero-mean Gaussian noises ϕᵢₖ and η^{ν}ₖ. The Gaussian noise is expressed as η^{V}ᵢⱼ=[Δϕ^{T}ᵢⱼ, Δp^{T}ᵢⱼ]^{T}˜ [symbol] (0_{6×1}, Σ^{V}ᵢⱼ), then an error of estimation of the pose transformation is:

$${e}_{v} = {\sum }_{( i , j ) ∈ 𝒦} {‖ {r}_{i j}^{V} ‖}_{{\sum }_{i j}^{V}}^{2}$$

$${r}_{i j}^{V} = [ \begin{matrix}{r}_{Δ {R}_{i j}} \\ {r}_{Δ {p}_{i j}}\end{matrix} ] = [ \begin{matrix}Log ( Δ {\tilde{R}}_{i j}^{T} {R}_{i}^{T} {R}_{j} ) \\ {R}_{i}^{T} ( {p}_{j} - {p}_{i} ) - Δ {\tilde{p}}_{i j}\end{matrix} ] ,$$

where Log (·): SO(3)→R³ is a logarithmic mapping of a three-dimensional rotation.

In step 3.3, loop closure detection is performed to identify places that have been previously reached, so as to reduce a cumulative drift. In polar coordinates, the 4D radar point cloud is divided into grids, a 3D point cloud is mapped to a 2D matrix, and a value of each element in the matrix is a maximum energy intensity of radar points in a corresponding grid. As the vehicle moves, a cosine distance between a 2D matrix of the current frame and a 2D matrix generated by each of all previous keyframes is continuously searched for and computed, and if the distance is less than a set threshold, it is considered that a loop closure has been detected. Once a loop closure is detected, a relative pose transformation xx, between the current frame j and a submap composed of a loop closure frame k and nearby keyframes is computed using the registration method introduced in the point cloud registration step. Then, xxi is added to the pose graph as a loop closure factor between nodes corresponding to moments j and k. An error of estimation of the pose transformation is:

$${e}_{L} = {\sum }_{( k , j ) ∈ ℒ} {‖ Log ( {( {\tilde{x}}_{k j}^{L} )}^{- 1} {x}_{k}^{- 1} {x}_{j} ) ‖}_{{\sum }_{k j}^{L}}^{2}$$

where [symbol] includes all loop closure frames, Σₖⱼ^{L} is a corresponding covariance matrix, and Log (·): SE(3)→R⁶ is a logarithmic mapping of a three-dimensional transformation.

In step 3.4, graph optimization is performed, where the pose graph is established, error terms of all relative pose estimates are comprehensively considered, and optimal poses of the ego vehicle at all moments are estimated through graph optimization, implementing more accurate and robust localization and mapping. All nodes in the pose graph correspond to poses at different moments, and edges between the nodes correspond to relative pose transformations between different moments. The pose is expressed as x=(R, p)∈SE(3), where R and p are a rotation and a translation, respectively. The poses at all moments are expressed as X={xᵢ}, i∈ [symbol] , and the optimal pose X* is estimated by solving a nonlinear least squares problem:

$${x}^{*} = arg {min}_{x} {e}_{O} + {e}_{V} + {e}_{L} ,$$

where [symbol] includes all moments, and e_{O}, e_{V}, e_{L} respectively correspond to the errors of relative pose transformations obtained in different steps.

Those skilled in the art know that, in addition to implementing the system and the apparatus as well as various modules thereof provided by the present invention in the form of pure computer-readable program code, the system and the apparatus as well as various modules thereof provided by the present invention can certainly be implemented in the form of logic gates, switches, application-specific integrated circuits, programmable logic controllers, and embedded microcontrollers by logically programming the method steps to implement the same program. Therefore, the system and the apparatus as well as various modules thereof provided by the present invention may be considered as a hardware component, and the modules included therein for implementing various programs may also be considered as structures within the hardware component. The modules for implementing various functions may also be considered as both software programs for implementing methods and structures within the hardware component.

The specific embodiments of the present invention are described above. It should be understood that the present invention is not limited to the specific implementation described above, and various changes or modifications may be made by those skilled in the art within the scope of the claims, which does not affect the essential contents of the present invention. In case of no conflict, the embodiments in the present application and the features in the embodiments can be combined with each other. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

1. A pose graph SLAM computation method based on a 4D millimeter-wave radar, the method comprising:
step S1: extracting a ground point cloud, and comparing two consecutive frames of point clouds, to remove ghost points below the ground and random points;
step S2: estimating a linear velocity and an angular velocity of a device based on Doppler velocity information in a 4D radar point cloud; and
step S3: estimating and constructing a pose graph using a relative pose transformation that is obtained through point cloud registration performed based on a normal distribution transformation, pre-integration performed using an estimated device velocity, and loop closure detection; and estimating an optimal pose through graph optimization.

2. The pose graph SLAM computation method based on a 4D millimeter-wave radar according to claim 1, wherein in step S1,
the ground point cloud is extracted, and the two consecutive frames of point clouds are compared, to remove the ghost points below the ground and the unstable random points, so as to reduce noise in the 4D radar point cloud, wherein step S1 comprises the following steps:
step S1.1: ghost point removal, wherein the ground point cloud is extracted from an original radar point cloud and the ghost points below the ground are filtered out;
for the original radar point cloud [symbol] ={Pᵢ}, i∈{1, 2, . . . , n} measured by a 4D radar, n is a number of points in the point cloud;
a position of each point in a radar coordinate system is expressed as Pᵢ= (xᵢ, yᵢ, zᵢ)^{T}=(rᵢ cos θᵢ cos φᵢ, rᵢ sin θᵢ cos φᵢ, rᵢ sin φᵢ)^{T}, wherein rᵢ is a distance of the point measured by the 4D radar, θᵢ is an azimuth angle of the point measured by the 4D radar, and φᵢ is an elevation angle of the point measured by the 4D radar; and
for the original radar point cloud, a point with a distance less than a threshold δᵣ and a height within a threshold δₕ near a mounting height of the radar is retained, an upward normal vector of each point is computed using a principal component analysis method, a point with a normal vector having an angle less than δₙ with a z-axis positive unit vector is retained, ground points are extracted using a random sample consensus algorithm, and the ghost points below the ground are filtered out; and
step S1.2: random point removal, wherein the random points are identified and filtered out by comparing a current point cloud and a previous frame of point cloud adjacent to the current point cloud, for the current point cloud and the previous frame of point cloud adjacent to the current point cloud, a pose transformation between the current point cloud and the previous frame of point cloud is computed based on the device velocity, the previous frame of point cloud is transformed into a coordinate system of the current frame, and if the transformed previous frame of point cloud does not exist within a preset range near a point in the current frame, the point is classified as a random point and filtered out; and
a rotation transformation Rₖ₋₁ and a translation transformation tₖ₋₁ between the current point cloud [symbol] ₖ and the previous frame of point cloud [symbol] ₖ₋₁ adjacent to the current point cloud are computed:
$${t}_{k - 1} = {\tilde{v}}_{k - 1} Δ t$$
$${R}_{k - 1} = Exp ( {\overline{ω}}_{k - 1} Δ t )$$
wherein \tilde{ν}ₖ₋₁ and \tilde{ω}ₖ₋₁ are respectively a device linear velocity estimate and a device angular velocity estimate of the previous frame, Δt is a time difference between the two frames, Exp(·):3→SO(3) is an exponential mapping of a three-dimensional rotation, R³ is a three-dimensional real number vector space, SO(3) is a three-dimensional special orthogonal group, and [symbol] ₖ₋₁ is obtained by transforming the previous frame of point cloud into the coordinate system of the current frame using Rₖ₋₁ and tₖ₋₁; and if no point in [symbol] ₖ₋₁ exists within a preset range of a point in the current frame, the current point is classified as a random point and filtered out.

3. The pose graph SLAM computation method based on a 4D millimeter-wave radar according to claim 1, wherein in step S2, the following steps are comprised:
step S2.1: static point extraction, wherein for an i^{th} point in the 4D radar point cloud, a relationship between a Doppler velocity of the point and a velocity of the radar is as follows:
$${v}_{r , i} = - {d}_{i} \cdot {v}_{s}$$
wherein v_{r,i} is the Doppler velocity of the i^{th} point, dᵢ= (cos θᵢ cos φᵢ, sin θᵢ cos φᵢ, sin φᵢ) T is a unit direction vector of the point relative to the radar, and vs is the velocity of the radar; and
a relationship between the velocity of the radar and the device velocity is as follows:
$${v}_{s} = {R}_{s}^{T} ( \tilde{v} + \tilde{ω} \times {t}_{s} )$$
wherein tₛ and Rₛ are respectively a mounting position and a pose of the 4D radar in a device coordinate system, \tilde{ν}∈R³ and \tilde{ω}∈R³ are respectively the linear velocity and the angular velocity of the device, and for all static points in the 4D radar point cloud, the Doppler velocity and the device velocity both conform to the following equation:
$$- [ \begin{matrix}{v}_{r , 1} \\ ⋮ \\ {v}_{r , m}\end{matrix} ] = [ \begin{matrix}{d}_{i}^{T} \\ ⋮ \\ {d}_{m}^{T}\end{matrix} ] {R}_{s}^{T} [ {I}_{3 \times 3} - {t}_{s}^{∧} [ \begin{matrix}\tilde{v} \\ \tilde{ω}\end{matrix} ] ,$$
wherein m is a number of all the static points in the point cloud, I_{3×3} is a 3×3 unit matrix, t^{∧}ₛ∈R^{3×3} is an antisymmetric matrix of tₛ, R^{3×3} represents a set of 3×3 real matrices, and dynamic outliers are removed and the static points are extracted based on relationships between Doppler velocities of all the static points in the radar point cloud and the device velocity using the random sample consensus algorithm; and
step S2.2: least squares estimation, wherein after the static points are extracted, the device velocity is computed based on the relationships between the Doppler velocities of all the static points and the device velocity using the least square method.

4. The pose graph SLAM computation method based on a 4D millimeter-wave radar according to claim 1, wherein in step S3,
pose graph optimization is performed, wherein the pose graph is estimated and constructed using the relative pose transformation that is obtained through the point cloud registration, the velocity pre-integration, and the loop closure detection; and finally the optimal pose is estimated through the graph optimization, wherein the following steps are comprised:
step S3.1: point cloud registration based on the normal distribution transformation, wherein a relative transformation is estimated by matching between a current 4D radar point cloud and a keyframe submap;
a radar submap is established using a plurality of keyframe point clouds and a sliding window, if a translation or rotation from a last keyframe to a current point cloud exceeds a threshold, a current frame is selected as a new keyframe, the new keyframe is added to the radar submap, and when a number of keyframes in the submap exceeds a size of the window, the earliest keyframe is discarded; and
after the radar submap is established, the submap is evenly divided into grids of a same size, a point cloud in each grid is modeled as a local normal distribution, measurement uncertainty of each point is considered when computing a mean and a covariance of the normal distribution, and the current 4D radar point cloud is registered with the radar submap to compute a relative pose transformation that maximizes a distribution probability of the current point cloud in the submap, wherein an error of estimation of the pose transformation is e_{O}; and
step S3.2: velocity pre-integration, wherein the relative pose transformation is computed based on the estimated device velocity, so that an additional reliable relative pose estimate is introduced, and a device linear velocity and a device angular velocity that are estimated at a moment t are respectively denoted as t and \tilde{ω}ₜ, with their estimated values being true values each plus a zero-mean Gaussian white noise:
$${\tilde{ω}}_{t} = {ω}_{t} + {η}_{t}^{ω} ,$$
$${\tilde{ν}}_{t} = {R}_{t}^{T} {}_{W} {v}_{t} + {η}_{t}^{v} ,$$
wherein ωₜ and _{w}Vₜ are respectively the true values of the angular velocity and the linear velocity in a world coordinate system, η^{ω}ₜ and η^{ν}ₜ are corresponding noise terms, Rₜ is an orientation of the device in the world coordinate system, a relative rotation transformation ΔRᵢⱼ and a relative translation transformation Δpᵢⱼ between a moment i and a moment j are obtained by integration, and an error of estimation of the pose transformation is e_{V}.

5. The pose graph SLAM computation method based on a 4D millimeter-wave radar according to claim 4, comprising the following steps:
step S3.3: loop closure detection, wherein a position that has been previously reached is identified, in polar coordinates, the 4D radar point cloud is divided into grids, a 3D point cloud is mapped to a 2D matrix, a value of each element in the matrix is a maximum energy intensity of radar points in a corresponding grid, as the device moves, a cosine distance between a 2D matrix of the current frame and a 2D matrix generated by each of all previous keyframes is continuously searched for and computed, and if the distance is less than a set threshold, it is considered that a loop closure has been detected; when a loop closure is detected, a relative pose transformation between the current frame and a submap composed of a loop closure frame and nearby keyframes is computed; and an error of estimation of the pose transformation is e_{L}; and
step S3.4: graph optimization, wherein the pose graph is established, error terms of relative pose estimates at all moments are considered, optimal poses of the device at all moments are estimated through graph optimization, all nodes in the pose graph correspond to poses at different moments, and edges between the nodes correspond to relative pose transformations between different moments; and
all the poses are expressed as X={xᵢ}, i∈ [symbol] , and the optimal pose X* is estimated by solving a nonlinear least squares problem:
$${𝒳}^{*} = arg {min}_{𝒳} {e}_{O} + {e}_{V} + {e}_{L}$$
wherein [symbol] comprises all moments, and e_{O}, e_{V}, e_{L} respectively correspond to the errors of relative pose transformations obtained in different steps.

6. A pose graph SLAM computation system based on a 4D millimeter-wave radar, comprising:
a module M1 configured to extract a ground point cloud, and compare two consecutive frames of point clouds, to remove ghost points below the ground and random points;
a module M2 configured to estimate a linear velocity and an angular velocity of a device based on Doppler velocity information in a 4D radar point cloud; and
a module M3 configured to estimate and construct a pose graph using a relative pose transformation that is obtained through point cloud registration performed based on a normal distribution transformation, pre-integration performed using an estimated device velocity, and loop closure detection; and estimate an optimal pose through graph optimization.

7. The pose graph SLAM computation system based on a 4D millimeter-wave radar according to claim 6, wherein in the module M1,
the ground point cloud is extracted, and the two consecutive frames of point clouds are compared, to remove the ghost points below the ground and the unstable random points, so as to reduce noise in the 4D radar point cloud, wherein a module M1.1 is configured to perform the following operation: ghost point removal, wherein the ground point cloud is extracted from an original radar point cloud and the ghost points below the ground are filtered out;
for the original radar point cloud [symbol] ={Pᵢ}, i E {1, 2, . . . , n} measured by a 4D radar, n is a number of points in the point cloud;
a position of each point in a radar coordinate system is expressed as Pᵢ= (xᵢ, yᵢ, zᵢ)^{T}=(rᵢ cos θᵢ cos φᵢ, rᵢ sin θᵢ cos φᵢ, rᵢ sin φᵢ)^{T}, wherein rᵢ is a distance of the point measured by the 4D radar, θᵢ is an azimuth angle of the point measured by the 4D radar, and φᵢ is an elevation angle of the point measured by the 4D radar; and
for the original radar point cloud, a point with a distance less than a threshold δᵣ and a height within a threshold on near a mounting height of the radar is retained, an upward normal vector of each point is computed using a principal component analysis method, a point with a normal vector having an angle less than δₙ with a z-axis positive unit vector is retained, ground points are extracted using a random sample consensus algorithm, and the ghost points below the ground are filtered out; and
a module M1.2 is configured to perform the following operation: random point removal, wherein the random points are identified and filtered out by comparing a current point cloud and a previous frame of point cloud adjacent to the current point cloud, for the current point cloud and the previous frame of point cloud adjacent to the current point cloud, a pose transformation between the current point cloud and the previous frame of point cloud is computed based on the device velocity, the previous frame of point cloud is transformed into a coordinate system of the current frame, and if the transformed previous frame of point cloud does not exist within a preset range near a point in the current frame, the point is classified as a random point and filtered out; and
a rotation transformation Rₖ₋₁ and a translation transformation tₖ₋₁ between the current point cloud [symbol] ₖ and the previous frame of point cloud [symbol] ₖ₋₁ adjacent to the current point cloud are computed:
$${t}_{k - 1} = {\tilde{v}}_{k - 1} Δ t$$
$${R}_{k - 1} = Exp ( {\tilde{ω}}_{k - 1} Δ t )$$
wherein \tilde{ν}ₖ₋₁ and \tilde{ω}ₖ₋₁ are respectively a device linear velocity estimate and a device angular velocity estimate of the previous frame, Δt is a time difference between the two frames, Exp(·):3→SO(3) is an exponential mapping of a three-dimensional rotation, R³ is a three-dimensional real number vector space, SO(3) is a three-dimensional special orthogonal group, and [symbol] ₖ₋₁ is obtained by transforming the previous frame of point cloud into the coordinate system of the current frame using Rₖ₋₁ and tₖ₋₁; and if no point in [symbol] ₖ₋₁ exists within a preset range of a point in the current frame, the current point is classified as a random point and filtered out.

8. The pose graph SLAM computation system based on a 4D millimeter-wave radar according to claim 6, wherein in the module M2,
a module M2.1 is configured to perform the following operation: static point extraction, wherein for an i^{th} point in the 4D radar point cloud, a relationship between a Doppler velocity of the point and a velocity of the radar is as follows:
$$vr , = - di \cdot s$$
wherein v_{r,i} is the Doppler velocity of the i^{th} point, dᵢ=(cos θᵢ cos φᵢ, sin θᵢ cos φᵢ, sin φᵢ) T is a unit direction vector of the point relative to the radar, and vs is the velocity of the radar; and
a relationship between the velocity of the radar and the device velocity is as follows:
$${v}_{s} = {R}_{s}^{T} ( \tilde{v} + \tilde{ω} \times {t}_{s} )$$
wherein tₛ and Rₛ are respectively a mounting position and a pose of the 4D radar in a device coordinate system, \tilde{ν}∈R³ and \tilde{ω}∈R³ are respectively the linear velocity and the angular velocity of the device, and for all static points in the 4D radar point cloud, the Doppler velocity and the device velocity both conform to the following equation:
$$- [ \begin{matrix}{v}_{r , 1} \\ ⋮ \\ {v}_{r , m}\end{matrix} ] = [ \begin{matrix}{d}_{i}^{T} \\ ⋮ \\ {d}_{m}^{T}\end{matrix} ] {R}_{s}^{T} [ {I}_{3 \times 3} - {t}_{s}^{∧} ] [ \begin{matrix}\tilde{v} \\ \tilde{ω}\end{matrix} ] ,$$
wherein m is a number of all the static points in the point cloud, I_{3×3} is a 3×3 unit matrix, t^{∧}ₛ∈R^{3×3} is an antisymmetric matrix of tₛ, R^{3×3} represents a set of 3×3 real matrices, and dynamic outliers are removed and the static points are extracted based on relationships between Doppler velocities of all the static points in the radar point cloud and the device velocity using the random sample consensus algorithm; and
a module M2.2 is configured to perform the following operation: least squares estimation, wherein after the static points are extracted, the device velocity is computed based on the relationships between the Doppler velocities of all the static points and the device velocity using the least square method.

9. The pose graph SLAM computation system based on a 4D millimeter-wave radar according to claim 6, wherein in the module M3,
pose graph optimization is performed, wherein the pose graph is estimated and constructed using the relative pose transformation that is obtained through the point cloud registration, the velocity pre-integration, and the loop closure detection;
and finally the optimal pose is estimated through the graph optimization, wherein a module M3.1 is configured to perform the following operation: point cloud registration based on the normal distribution transformation, wherein a relative transformation is estimated by matching between a current 4D radar point cloud and a keyframe submap;
a radar submap is established using a plurality of keyframe point clouds and a sliding window, if a translation or rotation from a last keyframe to a current point cloud exceeds a threshold, a current frame is selected as a new keyframe, the new keyframe is added to the radar submap, and when a number of keyframes in the submap exceeds a size of the window, the earliest keyframe is discarded; and
after the radar submap is established, the submap is evenly divided into grids of a same size, a point cloud in each grid is modeled as a local normal distribution, measurement uncertainty of each point is considered when computing a mean and a covariance of the normal distribution, and the current 4D radar point cloud is registered with the radar submap to compute a relative pose transformation that maximizes a distribution probability of the current point cloud in the submap, wherein an error of estimation of the pose transformation is e_{O}; and
a module M3.2 is configured to perform the following operation: velocity pre-integration, wherein the relative pose transformation is computed based on the estimated device velocity, so that an additional reliable relative pose estimate is introduced, and a device linear velocity and a device angular velocity that are estimated at a moment t are respectively denoted as νₜ and @t, with their estimated values being true values each plus a zero-mean Gaussian white noise:
$$\begin{matrix}{\tilde{ω}}_{t} = {ω}_{t} + {η}_{t}^{ω} , \\ {\tilde{v}}_{t} = {R}_{t}^{T} {}_{W} {ν}_{t} + {η}_{t}^{v} ,\end{matrix}$$
wherein ωₜ and Vₜ are respectively the true values of the angular velocity and the linear velocity in a world coordinate system, η^{ω}ₜ and η^{ν}ₜ are corresponding noise terms, Rₜ is an orientation of the device in the world coordinate system, a relative rotation transformation ΔRᵢⱼ and a relative translation transformation Δpᵢⱼ between a moment i and a moment j are obtained by integration, and an error of estimation of the pose transformation is e_{V}.

10. The pose graph SLAM computation system based on a 4D millimeter-wave radar according to claim 9, wherein
a module M3.3 is configured to perform the following operation: loop closure detection, wherein a position that has been previously reached is identified, in polar coordinates, the 4D radar point cloud is divided into grids, a 3D point cloud is mapped to a 2D matrix, a value of each element in the matrix is a maximum energy intensity of radar points in a corresponding grid, as the device moves, a cosine distance between a 2D matrix of the current frame and a 2D matrix generated by each of all previous keyframes is continuously searched for and computed, and if the distance is less than a set threshold, it is considered that a loop closure has been detected; when a loop closure is detected, a relative pose transformation between the current frame and a submap composed of a loop closure frame and nearby keyframes is computed; and an error of estimation of the pose transformation is e_{L}; and
a module M3.4 is configured to perform the following operation: graph optimization, wherein the pose graph is established, error terms of relative pose estimates at all moments are considered, optimal poses of the device at all moments are estimated through graph optimization, all nodes in the pose graph correspond to poses at different moments, and edges between the nodes correspond to relative pose transformations between different moments; and all the poses are expressed as X={xᵢ}, i∈ [symbol] , and the optimal pose X* is estimated by solving a nonlinear least squares problem:
$${x}^{*} = arg {min}_{x} {e}_{O} = {e}_{V} + {e}_{L}$$
wherein [symbol] comprises all moments, and e_{O}, e_{V}, e_{L} respectively correspond to the errors of relative pose transformations obtained in different steps.

11. A pose graph SLAM computation method based on a 4D millimeter-wave radar, the method comprising:
extracting a ground point cloud and comparing two consecutive frames of point clouds of a 4D radar point cloud generated by the 4D millimeter-wave radar to remove ghost points below the ground point cloud and random points from the 4D radar point cloud to create a filtered 4D radar point cloud;
estimating a linear velocity and an angular velocity of a device based on Doppler velocity information associated with the 4D radar point cloud; and
estimating and constructing a pose graph using a relative pose transformation and estimation of an optimal pose, the relative pose transformation being obtained through point cloud registration performed based on a normal distribution transformation, pre-integration performed using an estimated device velocity, and loop closure detection, the optimal pose being estimated through graph optimization.

12. The method of claim 11, wherein extracting the ground point cloud comprises extracting the ground point cloud using a random sample consensus algorithm on the 4D radar point cloud measured by the 4D millimeter-wave radar,
wherein the 4D radar point cloud includes a number of points positioned in a radar coordinate system, removing the ghost points from the 4D radar point cloud further comprising retaining each point of the number of points with a distance less than a threshold distance (δᵣ), a height within a height threshold (δₕ), and an upward normal vector having an angle less than a threshold angle (δₙ) with a z-axis positive unit vector, the upward normal vector being computed using a principal component analysis method, and
wherein removing the random points comprises comparing a current point cloud frame and a previous frame of the 4D radar point cloud adjacent to the current point cloud frame by computing a pose transformation between the current point cloud frame and the previous frame based on the device velocity to transform the previous frame into a coordinate system of the current point cloud frame, and if the previous frame after being transformed does not exist within a preset range near a point in the current point cloud frame, the point in the current point cloud frame is classified as a random point and filtered out.

13. The method of claim 12, wherein computing the pose transformation comprises:
computing a rotation transformation (Rₖ₋₁) between the current point cloud frame ( [symbol] ₖ) and the previous frame ( [symbol] ₖ₋₁) based on an exponential function of a product of a device angular velocity estimate (\tilde{ω}ₖ₋₁) of the previous frame ( [symbol] ₖ₋₁) and a time difference (Δt) between the current point cloud frame ( [symbol] ₖ) and the previous frame ( [symbol] ₖ₋₁);
computing a translation transformation (tₖ₋₁) between the current point cloud frame ( [symbol] ₖ) and the previous frame ( [symbol] ₖ₋₁) based on a product of a device linear velocity estimate (\tilde{ν}ₖ₋₁) of the previous frame ( [symbol] ₖ₋₁) and the time difference (Δt) between the current point cloud frame ( [symbol] ₖ) and the previous frame ( [symbol] ₖ₋₁); and
transforming the previous frame ( [symbol] ₖ₋₁) into the coordinate system of the current point cloud frame ( [symbol] ₖ) using the rotation transformation (Rₖ₋₁) and the translation transformation (tₖ₋₁) to provide a transformed previous frame ( [symbol] ₖ₋₁),
wherein the current point is classified as a random point and filtered out if no point in the transformed previous frame ( [symbol] ₖ₋₁) exists within a preset range of the current point in the current point cloud frame ( [symbol] ₖ).
